(19) United States
(12) Patent Application Publication
(10) Pub. No.: US 2025/0180900 A1
(43) Pub. Date: Jun. 5, 2025

(54) WAVEGUIDE-BASED PROJECTOR DEVICES

(71) Applicant: TEXAS INSTRUMENTS INCORPORATED, Dallas, TX (US)

(72) Inventors: John Marshall FERRI, Allen, TX (US); Gavin Camillo Utley PERRELLA, Dallas, TX (US)

(21) Appl. No.: 18/678,750

(22) Filed: May 30, 2024

Related U.S. Application Data
(60) Provisional application No. 63/605,873, filed on Dec. 4, 2023.

(51) Int. Cl. G02B 27/01

(52) U.S. Cl. CPC G02B 27/0101; G02B 2027/0123

(57) ABSTRACT

In examples, a device comprises an optical waveguide and first and second ports on the optical waveguide, the second port larger than the first port. The device also comprises a first set of lenses optically coupled to the first port and a second set of lenses optically coupled to the second port.

### CROSS-REFERENCE TO RELATED APPLICATIONS

The present application claims priority to U.S. Provisional Patent Application No. 63/605,873, which was filed Dec. 4, 2023, is titled “SCREENLESS HEAD-UP DISPLAY PICTURE GENERATING UNIT,” and is hereby incorporated herein by reference in its entirety.

### BACKGROUND

Head-up displays (HUDs) in automobiles are transparent displays that present information such as vehicle speed, navigation instructions, and other relevant data onto a windshield. These systems typically use projection technology to display information in the driver's line of sight, allowing the driver to access essential data without looking away from the road. HUDs vary in complexity, from basic speed and navigation information to more advanced features like augmented reality overlays.

### SUMMARY

In examples, a device comprises an optical waveguide and first and second ports on the optical waveguide, the second port larger than the first port. The device also comprises a first set of lenses optically coupled to the first port and a second set of lenses optically coupled to the second port.

### BRIEF DESCRIPTION OF THE DRAWINGS

FIG. 1 is a block diagram of a waveguide-based projector device, in accordance with various examples.

FIG. 2 is a schematic diagram of a vehicle including a waveguide-based projector device, in accordance with various examples.

FIG. 3 is a schematic diagram of a system including a waveguide-based projector device, in accordance with various examples.

FIG. 4 is a schematic diagram of a system including a waveguide-based projector device, in accordance with various examples.

FIG. 5 is a schematic diagram of a light source in a waveguide-based projector device, in accordance with various examples.

FIGS. 6A-6C and 7A-7C are schematic diagrams of example waveguides useful in a waveguide-based projector device, in accordance with various examples.

FIG. 8 is a schematic diagram of a set of lenses in a system having a waveguide-based projector device, in accordance with various examples.

FIG. 9 is a schematic diagram of a set of lenses in a system having a waveguide-based projector device, in accordance with various examples.

### DETAILED DESCRIPTION

Many projector systems include a light source to generate light, a light modulator (LM) (e.g., a digital micromirror device (DMD), spatial light modulator (SLM), liquid crystal on silicon (LCoS), thin film transistor (TFT)) to form images by modulating the light, and a network of prisms, lenses, and/or mirrors to bend and shape the modulated light provided by the SLM so an image is formed on a target. The target can be a screen, a wall, a display, a windshield, or any other suitable surface or region in space.

To view the formed image, also known as a virtual image, a viewer positions their eyes within an eyebox of the system. An eyebox is the specific region or volume in space within which the viewer must position their eyes to maintain a clear, consistent, and complete view of the projected image. Optical systems should be designed to have eyeboxes that are sufficiently large so the intended viewer can reliably position their eyes within the eyebox under normal operating conditions. For example, in the context of a head-up display (HUD) that provides a driver with images (e.g., speedometer data) on the windshield of the driver's automobile, the projector system of the HUD should produce an eyebox sufficiently large that both of the driver's eyes are consistently positioned within the eyebox. In this way, the driver enjoys a clear, consistent, and complete view of the image that the HUD projects.

Due to the small etendue of microdisplays such as LCOS, phase light modulators (PLM), TFTs, and DMDs, many projector-based HUD optical systems produce an eyebox that is too small, meaning that both of the viewer's eyes are not reliably positioned within the eyebox. To enlarge the eyebox into a practical size that covers both eyes simultaneously, projector-based HUD optical systems frequently include diffuser screens. A diffuser screen operates as an etendue expander by increasing the cone angle of the light transmitted or reflected from the diffuser screen through refractive, diffusing, or diffractive techniques, thereby increasing the etendue and enlarging the eyebox to an adequate size. However, diffuser screens may present undesirable effects. For example, the diffuser screen may create a backscattering effect in which the diffuser screen reflects ambient incident light (which may include sunlight, streetlights, or other external overhead light sources) and incorporates this ambient light into the virtual image, thereby degrading image quality and reducing contrast. The diffuser screen may also cause image blurring through the light diffusion process. Additionally, in applications where the HUD system is exposed to sunlight, this sunlight may be concentrated onto the diffuser screen by the HUD mirror optical system and cause damage to the diffuser screen.

This disclosure describes various examples of projector devices for HUD or other virtual image displays that mitigate the disadvantages associated with diffuser screens. In particular, the projector devices described herein omit diffuser screens and instead expand etendue and eyebox size by including an optical waveguide within a network of lenses in the projector device. A first set of projector device lenses emit light that creates an external optical pupil. The waveguide captures this light and replicates it to create an expanded pupil, thereby functioning as an etendue expander and enlarging the eyebox of the projector based HUD optical system. The waveguide emits the light of this expanded pupil which is then captured by the second set of projector lenses. The second set of projector lenses create an image (e.g., of a light modulator), which can be utilized as the source for another optical system that creates a virtual image display. Stated differently, the waveguide creates the same benefit as the diffuser screen (an enlarged eyebox) without suffering from the disadvantages associated with diffuser screens, such as the specific disadvantages described above.

The examples described herein provide numerous advantages. For example, because the diffuser screen is omitted, solar heating-related damage caused by the concentration of sunlight on the diffuser screen is eliminated. The backscattering effect in which the diffuser screen reflects ambient incident light and incorporates this light into the image being displayed is also eliminated. Further, the pupil expansion associated with the expanded etendue is optimized, meaning that the pupil is not overexpanded as in existing techniques, resulting in smaller waveguides and reduced manufacturing costs. The examples described herein are compatible with various types of projection devices, such as digital micromirror device, liquid crystal on silicon, TFT, etc. Similarly, the examples described herein are compatible with any type of polarization and light source, and they are easier and less expensive to manufacture than large automotive waveguides. Further still, the omission of diffuser screens facilitates the rapid adjustment of image position, such as the position of virtual images produced by the projection lenses disclosed herein, which can be useful in lenses having zoom capabilities. Additionally, in examples, projection lenses and optical elements of the HUD optical system can be optimized together because the absence of diffuser screens means that image phase information is maintained and useful to optimize projection lens and HUD mirror optical designs together. Further still, certain image-enhancing tools can be advantageously implemented in the examples described herein at reduced cost. For instance, expanded Pixel Resolution (XPR) can be implemented in pupil space at or near the entrance to the optical waveguide that replaces the diffuser screen as described above and at minimal cost, since the small size of the waveguide entrance means the XPR device is also small. The examples described herein also may provide various other advantages not expressly enumerated.

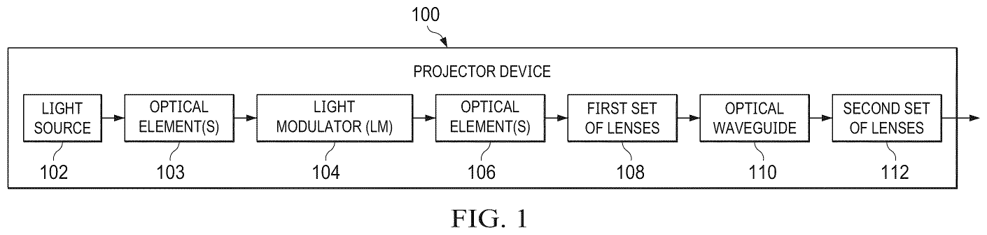

FIG. 1 is a block diagram of a waveguide-based projector device 100, in accordance with various examples. The projector device 100 may be a standalone projector device, or the projector device 100 may be included in another device or system, such as an automobile, an aircraft, a watercraft, a spacecraft, a video game console, an arcade video game unit, a smartphone, an entertainment device, an appliance, a laptop computer, a desktop computer, a tablet, a notebook, or any other suitable type of device or system. The projector device 100 may include a light source 102, one or more optical element(s) 103, a light modulator (LM) 104 (e.g., a PLM, SLM, LCOS, TFT), one or more optical element(s) 106, a first set of lenses 108, an optical waveguide 110, and a second set of lenses 112. The light source 102 may include any suitable type of light source, such as a light emitting diode (LED) light source, laser diode light source, ultra-high-pressure (UHP) lamp light source, laser-phosphor light source, or a hybrid light source that includes two or more of the foregoing types of light sources in any suitable combination. The LM 104 may include any suitable type of LM, such as a microelectromechanical systems (MEMS) mirror array (e.g., DMD). A liquid crystal display (LCD), LCOS, PLM, TFT, etc. also may be used for the LM 104.

The optical element(s) 103 and 106 may include prisms, lenses, mirrors, polarizers, filters, beam splitters, and any other optical element(s) suitable to achieve the functional objectives described herein. In some examples, the optical element(s) 103 and 106 may share one or more optical elements. For example, a prism may be considered as belonging to both optical element(s) 103 and 106 due to the position of the prism in the light flow pathway. However, in examples, the projector device 100 omits diffuser screens to avoid the technical disadvantages associated with diffuser screens for virtual displays such as HUDs, as described above. The first set of lenses 108 may include multiple lenses with a horizontal axis extending through the centers of the lenses. Examples of lenses in the first set of lenses 108 include reflective or refractive spherical, aspherical, off axis, and free form surfaces and can be bi-convex lenses, bi-concave lenses, plano-convex lenses, or plano-concave lenses. The optical waveguide 110 may include a waveguide having multiple ports on the waveguide or have ports positioned on the side of the waveguide. where the ports are at or near the entrance and exit pupils of the system of lenses. For example, in some cases optical waveguide 110 may contain a single port, or two or more ports may be included, with a first port being smaller than the second port. The ports may be positioned on a same side of the waveguide or on opposing sides of the waveguide. The second set of lenses 112 may include prisms, lenses, mirrors, polarizers, filters, beam splitters, and so on. However, as mentioned above, the projector device 100 omits diffuser screens to avoid the technical disadvantages associated with diffuser screens. The second set of lenses 112 may include multiple lenses with a horizontal axis extending through the centers of the lenses. Examples of lenses in the second set of lenses 112 include reflective or refractive spherical, aspherical, off axis, and free form surfaces and can be bi-convex lenses, bi-concave lenses, plano-convex lenses, or plano-concave lenses. In examples, the lenses in the second set of lenses 112 are larger (e.g., greater diameter) than the lenses in the first set of lenses 108.

Still referring to FIG. 1, in operation, the light source 102 provides light to the LM 104 by way of optical element(s) 103 (e.g., a prism). The LM 104 modulates the light (e.g., by adjusting mirrors in a mirror array of the LM 104 to modulate light reflecting off of the mirrors, by controlling cells of a liquid crystal cell array of the LM 104 to modulate light passing through the cells) and provides the light to optical element(s) 106. The optical element(s) 106, such as a prism, may receive and reflect the modulated light toward the first set of lenses 108. The first set of lenses 108 shape and bend the modulated light, providing the modulated light to the input port of the optical waveguide 110. More specifically, the modulated light may extend through the first port and into the waveguide, be reflected or guided within the waveguide, and exit the waveguide through the second port, which is larger than the first port. Because the second port is larger than the first port, the optical waveguide 110 operates as an etendue expander. Because the optical waveguide 110 operates as an etendue expander, diffuser screens are not needed to expand etendue and are omitted from the projector device 100. The second set of lenses 112 receives the modulated light from the optical waveguide through the second port and shapes and bends the modulated light to form an image at an output location of the projector device 100. For example, in the context of a HUD system in an automobile, the second set of lenses 112 provides the source image for a network of mirrors comprising a HUD mirror design. In turn, the network of mirrors provides the modulated light to a windshield of the automobile and then to the eyebox for viewing by the driver (or to a passenger if the HUD is positioned on the passenger side of the vehicle).

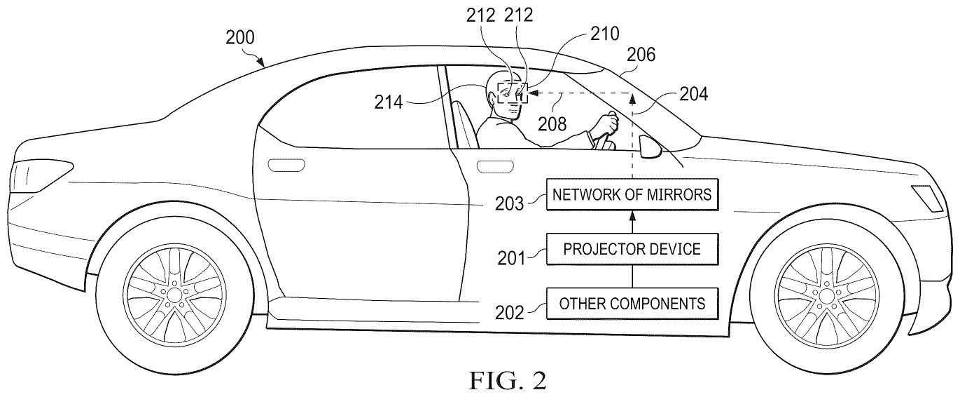

FIG. 2 is a schematic diagram of a vehicle 200 including a waveguide-based projector device, in accordance with various examples. FIG. 2 depicts vehicle 200 as being an automobile, but other types of systems and devices, such as motorcycle helmets, augmented reality devices, watercraft, military vehicles, aircraft, construction vehicles, farming equipment, and spacecraft are contemplated and included in the scope of this disclosure. The vehicle 200 includes a projector device 201, which may be part of a HUD system. The projector device 201 may be an example of the projector device 100 of FIG. 1. The projector device 100 may be coupled to other electronic components 202 of the vehicle 200, such as an electronic control unit (ECU) and/or other circuitry, processors, microcontrollers, etc. that may perform various operations. The projector device 201 is optically coupled to a network of mirrors 203. As used herein, the term “optically coupled” refers to the relative spatial alignment of optical components or devices in such a way that they can transmit or exchange light signals. The network of mirrors 203 includes one or more mirrors that convey modulated light provided by the projector device 201 to a glass surface 206 (e.g., windshield), as numeral 204 indicates. As numeral 208 indicates, modulated light from the glass surface 206 is provided to an eyebox 210. Eyes 212 of the driver 214 are positioned within the eyebox 210. The projector device 201, and specifically the optical waveguide 110 (FIG. 1), expands the system etendue such that the eyebox 210 is adequately large to accommodate both eyes 212, including ordinary spatial movements of the eyes 212 (e.g., movement of the head of the driver 214) that would be expected during operation of the vehicle 200.

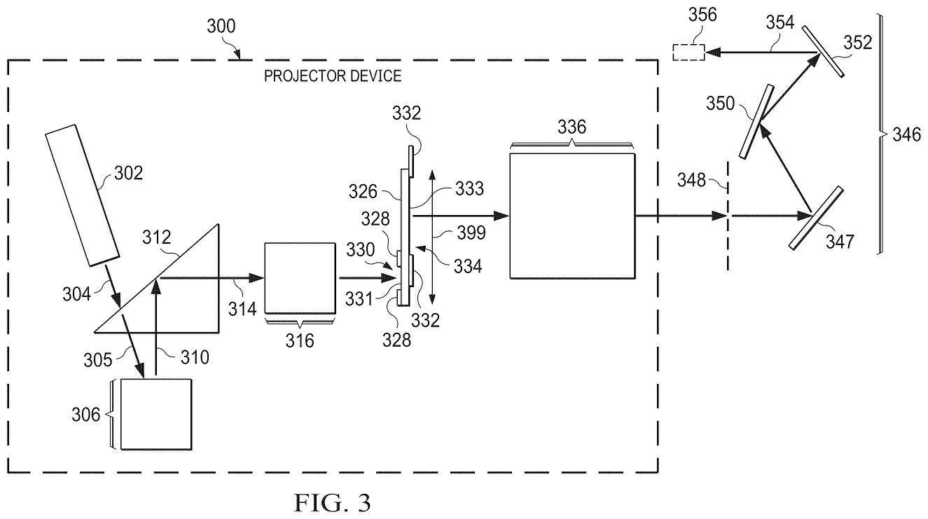

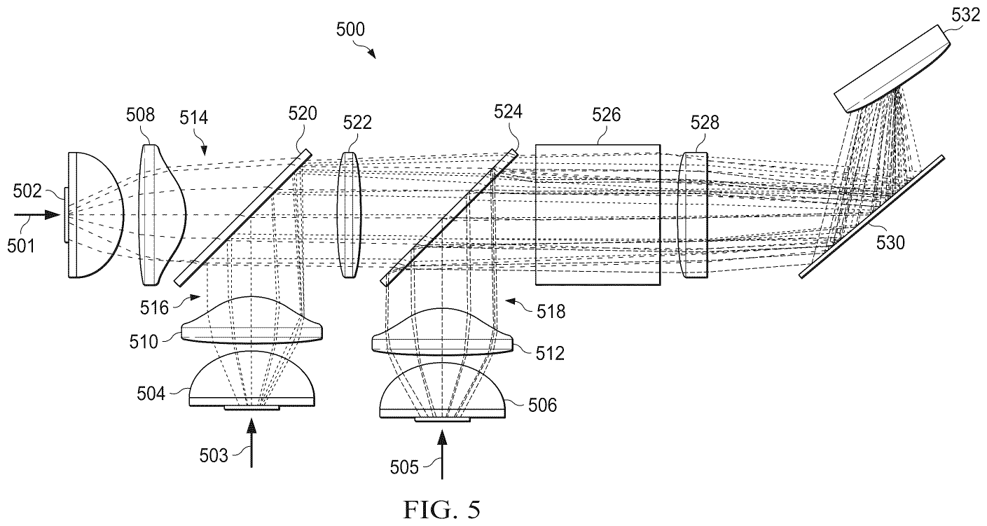

FIG. 3 is a schematic diagram of a system including a waveguide-based projector device 300, in accordance with various examples. The projector device 300 may be an example of the projector device 100 (FIG. 1) and/or an example of the projector device 201 (FIG. 2) and may be part of a HUD system. In examples, the projector device 300 may include a light source 302 (e.g., the light source 102 of FIG. 1). Example light sources 302 may include light emitting diodes, incandescent or high intensity discharge (HID) lamps, laser phosphor emitters (LaPh) and lasers, and FIG. 5 (described below) provides one possible light source configuration. The projector device 300 may include an LM 306 (e.g., a PLM, SLM, LCOS, TFT). Examples of the LM 306 may include LCDs, DMDs, and LCOS devices. When the LM 306 is a DMD, the LM 306 may include an array of micromirrors 308 to modulate light (denoted by numeral 304) provided by the light source 302.

In examples where the LM 306 is an LCOS, the LM 306 may include a transmissive surface or a reflective surface, such as a silicon surface, coated with a layer of liquid crystal material. This liquid crystal layer may be positioned between a transparent electrode and the reflective surface and thus may be influenced by an electric field. When the electric field is applied, the liquid crystal molecules align or reorient, altering the polarization of light passing through. Through precise control of the electric field across different regions of the liquid crystal layer using the aforementioned electrodes, LCOS devices can modulate the polarization of light, thereby adjusting the intensity and color of light reflected from the LCOS surface. In other examples, the LM 306 includes multiple pixels, each pixel including a TFT and a liquid crystal cell. The TFT operates as a switch, regulating the voltage applied to the liquid crystal cell. By varying the voltage, the orientation of the liquid crystal molecules can be changed, influencing the polarization of light traveling through them, thus adjusting the intensity and color of light provided.

The spatial relationship between the light source 302 and the LM 306 may vary depending on the type of LM 306 used. In examples, the light source 302 may be positioned behind the LM 306, in front of the LM 306, lateral to the LM 306, or in any other suitable position. The light source 302 provides light (as numeral 304 indicates) to the LM 306 by way of an optical element 312 (e.g., a prism), as numeral 305 indicates. The LM 306 provides modulated light (denoted by numeral 310) to the optical element 312. In some examples, the optical element 312 may represent two or more optically coupled optical elements. Other types of optical elements 312 may include reverse total internal reflection (RTIR) prisms, total internal reflection (TIR) prisms, field lenses, air gaps adequately large to allow separation of illumination and projection light paths, polarized beam splitter (PBS) cubes, dichroic mirrors, linear polarizers, and waveplates, among others.

The optical element 312 provides the modulated light to a first set of lenses 316, as numeral 314 indicates. The first set of lenses 316 may include any of a variety of lenses, in any suitable number, shape, type, and configuration, to shape and bend the modulated light to create a source of light that is compatible with the input to a waveguide 326. In some cases, this first set of lenses 316 is similar in design to eyepiece optics.

As a whole, the first set of lenses 316 is configured to create a pupil that is external to the lenses such that the pupil can be optically coupled into the waveguide 326. In examples, the image of the LM 306 is created at or near infinity so that the light can propagate through the waveguide 326 with minimal degradation of the image quality. In addition, the first set of lenses 316 directs the modulated light toward an aperture stop 328, and more specifically, through a port 330 on the waveguide 326. Accordingly, the first set of lenses 316 is optically coupled to the port 330 and to the LM 306. The port 330 may have a circular shape with a diameter ranging from 4 mm to 10 mm. Other shapes of the port 330 are contemplated and included in the scope of this disclosure. An example length 399 of the waveguide 326 may range from 30 mm to 80 mm.

An input coupling diffractive structure (ICDS) 331 is on the waveguide 326 at the port 330. The ICDS 331 is a specialized optical component configured to efficiently couple light into the waveguide 326. The ICDS 331 includes a pattern of diffractive microstructures such as gratings, lenses, or other diffractive elements. The ICDS 331 is configured to leverage optical diffraction to redirect incident light into the waveguide 326 with minimal loss and precise alignment. The ICDS 331 matches the spatial and spectral properties of the incoming light to those of the waveguide 326, optimizing the coupling efficiency.

The aperture stop 328, and specifically the port 330, controls the amount of light that enters the waveguide 326. In some examples, the aperture stop 328 is on the waveguide 326, and in other examples, the aperture stop 328 is positioned a distance away from the waveguide 326 (e.g., no more than 5 millimeters away from the waveguide 326), so that maximum optical coupling efficiency into the waveguide is achieved.

The performance of the waveguide 326 may depend on multiple properties of the waveguide 326, each of which may be selected to facilitate operation of the waveguide 326 as described herein. Such properties may include refractive index profile, physical dimensions, material composition, propagation loss, dispersion, and others. In examples, the waveguide 326 is composed of a material such as glass, plastics, or a combination thereof and may contain metal reflectors, partial mirrors, holographic optical elements, or diffraction gratings.

Having entered the waveguide 326 through the port 330, the modulated light undergoes reflections (e.g., total internal reflections), by which the modulated light is confined within and guided along the length (i.e., vertical height) of the waveguide 326. This phenomenon occurs due to the principle of total internal reflection, which holds that when light travels from a medium with a higher refractive index to a medium with a lower refractive index at an angle greater than the critical angle, the light is completely reflected back into the higher refractive index medium.

An aperture stop 332 may be on, or positioned a distance away from, the waveguide 326 (e.g., no more than 5 millimeters away from the waveguide 326), so that maximum optical coupling efficiency with the waveguide is achieved. In examples, the aperture stops 328, 332 are positioned on opposing sides of the waveguide 326, as shown. Modulated light being reflected within the waveguide 326 exits the waveguide 326 through the port 334. The port 334 has a width ranging between 20 mm and 75 mm, and a height ranging between 10 mm and 75 mm. The ports 330, 334 may have any suitable shape, including oval, circular, and rectangular shapes. The diameter of the pupil exiting the port 334 exceeds the diameter of the pupil entering the port 330, thereby providing an expanded etendue and enlarging the eyebox in which images formed by the projector device 300 may be viewed. Merely aligning the two pupils along a horizontal axis would not be adequate to expand etendue, because without the waveguide 326, the modulated light extending through the port 330 would not occupy the full diameter of the port 334. The waveguide 326 enables the modulated light extending through the port 330 to occupy the full diameter of the port 334 upon exiting the waveguide 326. This is because, as the light propagates inside the waveguide 326, the light undergoes multiple reflections and scatterings and thus, upon exiting the port 334, the light spreads and fills the entire aperture of the port 334 because the directionality of the light is randomized within the waveguide 326. In this manner, the etendue at port 334 is expanded relative to the smaller etendue at the port 330 defined by the aperture stop 328. An ICDS 333 is on the waveguide 326 at the port 334. The ICDS 333 is a specialized optical component configured to efficiently extract light from the waveguide 326. The ICDS 333 includes a pattern of diffractive microstructures such as gratings, lenses, or other diffractive elements. In examples, ICDS 333 may be configured to leverage optical diffraction to extract light from the waveguide 326 with minimal loss and precise alignment.

A second set of lenses 336 shapes and bends the modulated light that emits from the port 334 and forms a magnified, aerial image at location 348, although the scope of disclosure includes forming the magnified image on a surface, depending upon the application-specific configuration of elements in the system. A network of mirrors 346 (or other suitable optical elements, such as lenses) receives the modulated light and is configured to form a virtual image for the driver. Hence, the second set of lenses 336 is optically coupled to the port 334 and the network of mirrors 346. In examples, the lenses in the second set of lenses 336 are larger (e.g., larger diameter, such as approximately 50 mm) than the lenses in the first set of lenses 316 (e.g., smaller diameter, such as approximately 20 mm) because the second set of lenses 336 must accommodate the larger diameter bundle of light (e.g., expanded optical etendue) that exits the waveguide 326. In examples, the diameter ratio between the first set of lenses 316 and the second set of lenses 336 is approximately 2:5, although the scope of this disclosure is not limited as such.

As mentioned above, modulated light exiting the second set of lenses 336 forms a magnified, aerial image at location 348. The modulated light is subsequently reflected by multiple (e.g., two or more) mirrors 347, 350 in the network of mirrors 346 to reach a glass surface 352 (e.g., windshield, which, for convenience, is represented in FIG. 3 as being smaller than the actual size of a windshield) of the system in which the projector device 300 is included (e.g., vehicle 200 of FIG. 2). The glass surface 352 is optically coupled to the network of mirrors 346. The glass surface 352 partially reflects the modulated light from the network of mirrors 346 toward the eyebox 356, as numeral 354 indicates. The eyebox 356 is adequately large to accommodate the user's (e.g., driver's) eyes, even if the eyes move in space during the ordinary course of operating the system. The modulated light provided to the eyebox 356 may provide a variety of useful information, such as driving speed, acceleration, fuel status, mileage odometer, map direction, landmark identification tags, and more.

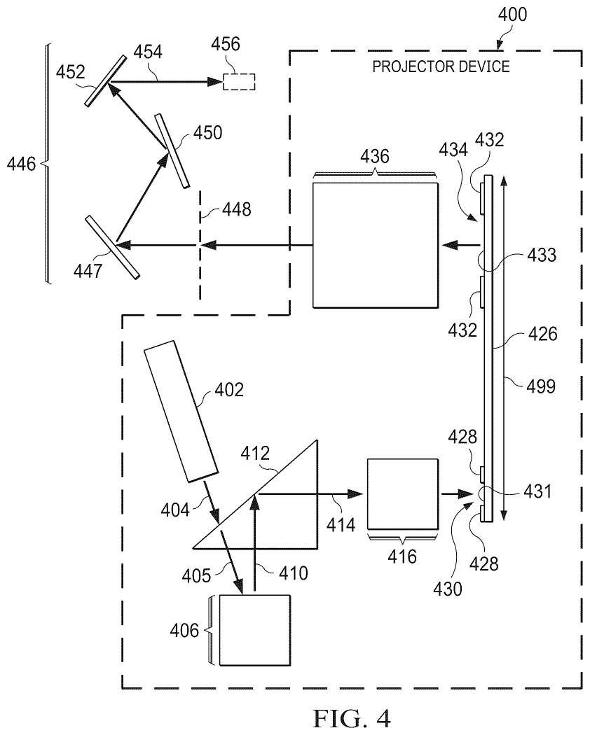

FIG. 4 is a schematic diagram of a system including a waveguide-based projector device 400, in accordance with various examples. The projector device 400 may be an example of the projector device 100 of FIG. 1 and/or the projector device 201 of FIG. 2 and may be part of a HUD system. In examples, the projector device 400 includes a light source 402 (similar to the light source 302 such that the description of light source 302 may also apply to light source 402), an optical element 412, such as a prism (similar to optical element 312 such that the description of optical element 312 may also apply to optical element 412), an LM 406 (similar to the LM 306 and optionally including an array of micromirrors 408 similar to the array of micromirrors 308, such that the descriptions of LM 306 and the array of micromirrors 308 may also apply to LM 406 and an array of micromirrors 408), a first set of lenses 416 (similar to the first set of lenses 316 in size and shape, such that the description of the first set of lenses 316 may also apply to the first set of lenses 416), and a waveguide 426 (having an example length 499 ranging from 30 mm to 80 mm) with aperture stops 428, 432 having ports 430, 434, respectively (similar to the waveguide 326 and aperture stops 328, 332 having ports 330, 334, respectively, such that the descriptions for waveguide 326 and aperture stops 328, 332 may also apply to waveguide 426 and aperture stops 428, 432). The ports 430, 434 may have any suitable shape, including oval, circular, and rectangular shapes. The projector device 400 includes ICDS 431 on the waveguide 426 at port 430 (similar to the ICDS 331 such that the description of ICDS 331 also may apply to ICDS 431), and an ICDS 433 on the waveguide 426 at port 434 (similar to the ICDS 333 such that the description of ICDS 333 also may apply to ICDS 433). The projector device 400 may also include a second set of lenses 436 (similar to the second set of lenses 336 in size and shape, such that the description of the second set of lenses 336 may also apply to the second set of lenses 436) and a network of mirrors 446 (similar to the network of mirrors 346, such that the description of the network of mirrors 346 also may apply to the network of mirrors 446), a glass surface 452 (e.g., a windshield; similar to the glass surface 352, such that the description of the glass surface 352 also may apply to the glass surface 452), and an eyebox 456 (similar to the eyebox 356 such that the description of the eyebox 356 also may apply to the eyebox 456). The first set of lenses 416 is optically coupled to the LM 406 and to the port 430, and the second set of lenses 436 is optically coupled to the port 434 and the network of mirrors 446. The glass surface 452 is optically coupled to the network of mirrors 446.

The structural features of the projector device 400 are similar to those of the projector device 300, except that the first and second sets of lenses 416 and 436, as well as the aperture stops 428 and 432 and the ICDSs 431 and 433, are located on the same side of the waveguide 426. To accommodate the first and second sets of lenses 416, 436 and the aperture stops 428, 432 and ICDSs 431, 433 on the same side of the waveguide 426, the length (the vertical height) of the waveguide 426 is increased relative to that of the waveguide 326 (e.g., 80 mm length for the waveguide 426 versus 30 mm length for the waveguide 326). In examples, the length of the waveguide 426 is variable and should be optimized for maximum performance of the waveguide, minimization of system cost, and/or any other parameters that are critical in the design. In examples, the lenses in the second set of lenses 436 are larger (e.g., greater diameter) than the lenses in the first set of lenses 416. Unless otherwise described, the physical dimensions and properties of the structures in FIG. 4 are, in at least some examples, identical to those of FIG. 3 and thus are not described again here.

The operation of the projector device 400 is similar to the operation of the projector device 300, described above. Thus, the operation of the projector device 400 is described only briefly. In operation, the light source 402 provides light to the LM 406 by way of the optical element 412, as numerals 404 and 405 indicate. The LM 406 may be any of the types of LMs 306 described above. For example, the LM 406 may be a DMD having an array of micromirrors 408, or another SLM or PLM such as those using LCOS or MEMS micromirror-based phase modulators. The LM 406 modulates light provided by the light source 402 and provides the modulated light to the optical element 412, as numeral 410 indicates. The optical element 412 may reflect the modulated light to the first set of lenses 416, as numeral 414 indicates. Because the port 434 is larger than the port 430, the port 434 operates as an etendue expander. This is because, as the light propagates inside the waveguide 426, the light undergoes multiple reflections and scatterings and thus, upon exiting the port 434 defined by the aperture stop 432, the light spreads and fills the entirety of the port 434 because the directionality of the light is randomized within the waveguide 426. In this manner, the etendue at port 434 is expanded relative to the smaller etendue at the port 430 defined by the aperture stop 428. The second set of lenses 436 shapes and bends the modulated light that emits from the port 434 and forms a magnified, aerial image at location 448. Like the network of mirrors 346, the network of mirrors 446 provides modulated light of the aerial image at location 448 to the glass surface 452 by way of mirrors 447 and 450. Like the glass surface 352, the glass surface 452 provides at least some of the modulated light to the eyebox 456, as numeral 454 indicates. The eyebox 456 is adequately large to accommodate the user's (e.g., driver's) eyes, even if the eyes move in space during the ordinary course of operating the system. The modulated light provided to the eyebox 456 may provide a variety of useful information, such as driving speed, acceleration, fuel status, mileage odometer, and more. The size of the eyebox 456 is enlarged relative to the size the eyebox 456 would have been, had the waveguide 426 and aperture stops 428, 432 not been configured to have expanded etendue.

The structures shown in FIGS. 3 and 4 both provide numerous advantages. For example, because the diffuser screen from prior solutions is omitted, ambient incident light (including solar light) does not reach the diffuser screen (e.g., through the networks of mirrors 346, 446), and thus solar heating-related damage caused by the concentration of sunlight on the diffuser screen is eliminated, as is the backscattering effect in which the diffuser screen reflects ambient incident light and incorporates this light into the image being displayed.

The optimal position for the waveguide entrance and exit ports 330, 334, 430, 434 are at the pupil locations of the lenses shown in FIGS. 3 and 4. When a waveguide is not at the pupil location, the waveguide and the exit port must be much larger for the viewer to see the entire field of view. This significantly reduces the image brightness. However, in the examples of FIGS. 3 and 4, the ports 330, 334 and 430, 434 may be positioned at the pupil locations of the lenses, thus mitigating the need for larger waveguides and exit ports, and producing brighter images.

The examples described with reference to FIGS. 3 and 4 are compatible with various types of projection devices, such as digital micromirror devices, liquid crystal on silicon, TFT, etc. More specifically, because the waveguides 326, 426 are positioned between the sets of lenses 316, 336 and the sets of lenses 416, 436, respectively, the waveguides are downstream of the LMs 306, 406, and thus any type of imaging device may be used as the LMs 306, 406.

Similarly, the examples described herein are compatible with any type of polarization and light source. For example, the waveguides 326, 426 may be designed to be insensitive to the polarization state of incoming light, meaning that the waveguides 326, 426 are compatible with various types of light sources, including unpolarized light emitting diode (LED) light, polarized laser light, etc. Additionally, certain technologies for the LMs 306, 406 can use LED light more efficiently than can other technologies, and so those technologies may be particularly useful with the waveguides 326, 426.

Further still, the omission of diffuser screens facilitates the rapid adjustment of image position, such as the position of the aerial image at locations 348, 448 produced by the projection lenses disclosed herein, which can be useful for lenses having zoom capabilities. Additionally, in examples, projection lenses (e.g., the lenses in the sets of lenses 316, 336, 416, 436) and optical elements of the HUD optical system (e.g., networks of mirrors 346, 446) can be optimized together because the absence of diffuser screens means that image phase information is maintained. The examples described herein also may provide various other advantages not expressly enumerated.

FIG. 5 is a schematic diagram of a light source 500 in a waveguide-based projector device, in accordance with various examples. For example, the light source 500 may be representative of the light sources 102, 302, and/or 402. The light source 500 may, for example, include one or more light sources (e.g., lamps, lasers, light emitting diodes (LEDs)) emitting light as numerals 501, 503, and 505 indicate, and this light is provided to lenses 502, 504, and 506, respectively. In examples, the light numerals 501, 503, and 505 include green, blue, and red light, respectively, which are known as the primary colors. Primary colors may be combined (e.g., by the projector devices 100, 300, and/or 400 using multiple LMs and/or time multiplexing) to form a variety of other colors, such as may be useful to create a wide variety of images. The light source 500 may include plano-convex lenses 508, 510, and 512, dichroic mirrors 520 and 524, a lens 522 between the dichroic mirrors 520 and 524, a fly's eye array 526, a plano-convex lens 528, a mirror 530, and a lens 532. In operation, green light numerals 501, blue light numeral 503, and red light numeral 505 are collimated by the pairs of lenses 502/508, 504/510, and 506/512, respectively, as numerals 514, 516, and 518 indicate, respectively. The dichroic mirror 520 combines the green and blue light (numerals 514 and 516), and the lens 522 compensates for the longer path length of the green and blue light (numerals 514 and 516) compared to the red light (numeral 518). The dichroic mirror 524 combines the red light (numeral 518) with the blue and green light (numerals 514 and 516). The fly's eye array 526 spatially homogenizes the combined red-blue-green light, and the plano-convex lens 528 converges the red-blue-green light output by the fly's eye array 526. The mirror 530 reflects the red-blue-green light, which is then further converged by lens 532, and is then output by the light source 500 (e.g., toward the LM 104, 306, and/or 406). The light source 500 may include additional components in any suitable configuration, such as light sources, lenses, prisms, light tunnels, and mirrors.

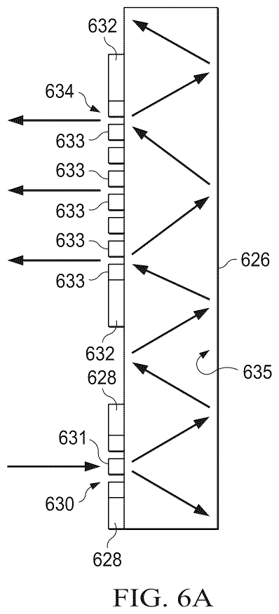

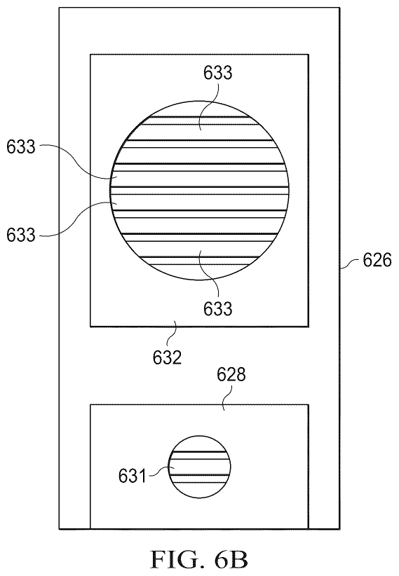

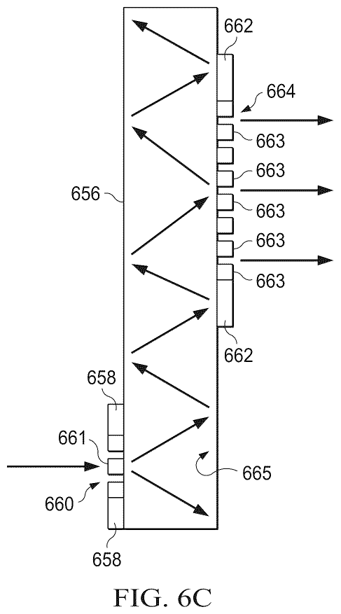

FIG. 6A is a schematic diagram of an example waveguide 626 including example ICDSs, such as the ICDSs 331, 333 and the ICDSs 431, 433, described above. In FIG. 6A, the waveguide 626 (which is an example of waveguides 326, 426 and may comprise any suitable material, such as glass, polymers, silicon, gallium arsenide, photonic crystals, metallic coatings) includes aperture stops 628, 632, which are similar to aperture stops 328, 332 and aperture stops 428, 432, with all such aperture stops 328, 332, 428, 432, 628, and 632 including a suitable material such as black anodized metal. The aperture stop 628 defines a port 630, which is similar to the ports 330 and 430. Further, the aperture stop 632 defines a port 634, which is similar to the ports 334 and 434. An ICDS 631 is positioned within the port 630, and an ICDS 633 is positioned within the port 634. In examples, the ICDS 631, 633 are diffractive gratings, which are composed of the same material as the remainder of the waveguide 626. Light enters the waveguide 626 through the ICDS 631, which diffracts the light. The diffracted light enters the waveguide 626 and reflects off of the internal walls of the waveguide 626. Light exits the waveguide 626 through the ICDS 633, which maintains the same ray angles as the input light for the exiting light. By including an ICDS 633 that is larger than the ICDS 631, as shown, the waveguide 626 expands etendue. Although FIG. 6A depicts the ICDS 631, 633 as being on the same surface of the waveguide 626 as the aperture stops 628, 632, in some examples, the ICDS 631, 633 may be positioned differently, for example, on multiple positions along the surface 635 of the waveguide 626. FIG. 6B is a possible profile view of the structure of FIG. 6A, in accordance with various examples. FIG. 6C is another example waveguide 656 that is similar the waveguide 626 of FIG. 6A, with components 656, 658, 660, 661, 662, 663, 664, and 665 of FIG. 6C corresponding to components 626, 628, 630, 631, 632, 633, 634, and 635 of FIG. 6A, respectively. However, in FIG. 6C, the aperture stop 662, the port 664, and the ICDS 663 are positioned on an opposite side of the waveguide 656 as the aperture stop 658. The operation of the waveguide 656 is similar to that of the waveguide 626, except that light exits the waveguides 626, 656 on opposite sides.

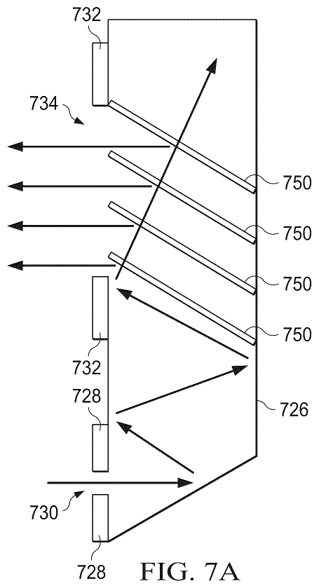

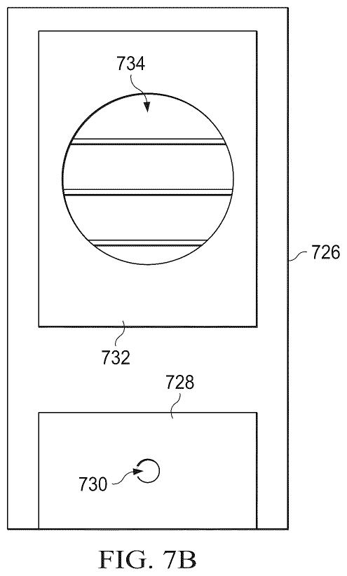

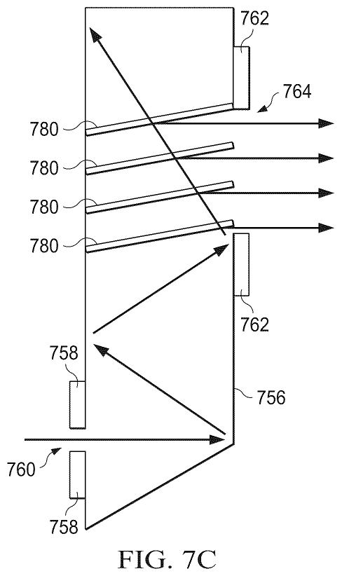

FIG. 7A is a schematic diagram of a waveguide 726, which is an example of waveguides 326, 426 and may comprise any suitable material, such as glass, polymers, silicon, gallium arsenide, photonic crystals, and metallic coatings. The waveguide 726 omits ICDSs, and instead of leveraging diffractive grating to expand etendue as in the waveguide 626 of FIG. 6A, the waveguide 726 instead uses partially reflective mirrors 750 to expand etendue. Light enters the waveguide 726 through a port 730 defined by an aperture stop 728, is reflected within the waveguide 726, and is partially reflected by each of the partially reflective mirrors 750. The portion of light reflected by the partially reflective mirrors 750 exits the waveguide 726 through a port 734 defined by an aperture stop 732. The aperture stops 728, 732 (e.g., composed of black anodized metal) are similar to the aperture stops 328, 332 and aperture stops 428, 432. The number of partially reflective mirrors 750 included in the waveguide 726 determines the degree of etendue expansion. As shown in FIG. 7A, the port 734 is larger than the port 730 to accommodate the expanded etendue. FIG. 7B is a possible profile view of the structure of FIG. 7A, in accordance with various examples. FIG. 7C is another example waveguide 756 that is similar to the waveguide 726 of FIG. 7A, with components 756, 758, 760, 762, 764, and 780 of FIG. 7C corresponding to components 726, 728, 730, 732, 734, and 750 of FIG. 7A, respectively. However, in FIG. 7C, the aperture stop 762 and the port 764 are positioned on an opposite side of the waveguide 756 as the aperture stop 758. The operation of the waveguide 756 is similar to that of the waveguide 726, except that light exits the waveguides 726, 756 on opposite sides.

The ports 630 (FIG. 6) and 730 (FIG. 7) may be sized such that certain image-enhancing tools can be advantageously implemented in the examples described herein at reduced cost. For instance, expanded Pixel Resolution (XPR) can be implemented in pupil space at or near the ports 630, 730 at minimal cost, since the small sizes of the ports 630, 730 means the XPR device is also small.

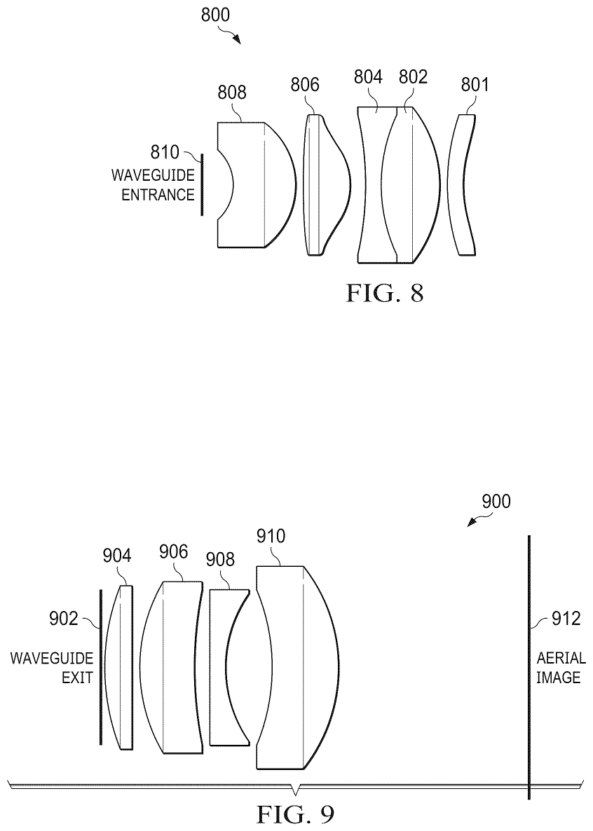

FIG. 8 is a schematic diagram of a set of lenses 800 in a system having a waveguide-based projector device, in accordance with various examples. In particular, the set of lenses 800 shown in FIG. 8 may be illustrative of the first set of lenses 316 (FIG. 3) and/or the first set of lenses 416 (FIG. 4). The set of lenses 800 includes lenses 801, 802, 804, 806, and 808, with lens 808 being in closest proximity to a port 810, such as the ports 330, 430, 630, and/or 730. The lenses 801, 802, 804, 806, and 808 may have any suitable shape, such as convex lenses, concave lenses, plano-convex lenses, plano-concave lenses, biconvex lenses, biconcave lenses, meniscus lenses, cylindrical lenses, aspheric lenses, achromatic doublet lenses, Fresnel lenses, gradient-index lenses, and any other suitable type of lens. Although the set of lenses 800 is depicted as including five lenses, the set of lenses 800 may include any number of lenses. In examples, the lenses 801, 802, 804, 806, and 808 may have diameters of approximately 20 mm. The lenses 801, 802, 804, 806, and 808 may bend and shape the light received (e.g., from the optical element 312 (FIG. 3) or optical element 412 (FIG. 4)) and may provide the light to the port 810.

FIG. 9 is a schematic diagram of a set of lenses 900 in a system having a waveguide-based projector device, in accordance with various examples. In particular, the set of lenses 900 shown in FIG. 9 may be illustrative of the second set of lenses 336 (FIG. 3) and/or the second set of lenses 436 (FIG. 4). The set of lenses 900 includes lenses 904, 906, 908, and 910, with lens 904 being in closest proximity to a port 902, such as the ports 334, 434, 634, and/or 734, and with lens 910 being in closest proximity to an aerial image 912 (e.g., aerial image at location 348 (FIG. 3) or aerial image at location 448 (FIG. 4)) formed by the set of lenses 900. The lenses 904, 906, 908, and 910 may have any suitable shape, such as convex lenses, concave lenses, plano-convex lenses, plano-concave lenses, biconvex lenses, biconcave lenses, meniscus lenses, cylindrical lenses, aspheric lenses, achromatic doublet lenses, Fresnel lenses, gradient-index lenses, and any other suitable type of lens. Although the set of lenses 900 is depicted as including five lenses, the set of lenses 900 may include any number of lenses. In examples, the lenses 904, 906, 908, and 910 may have diameters of approximately 50 mm. The diameter ratio between the lenses in the set of lenses 800 and the lenses in the set of lenses 900 may be approximately 2:5, although the scope of this disclosure is not limited as such.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A device, comprising:
an optical waveguide;
first and second ports on the optical waveguide, the second port larger than the first port;
a first set of lenses optically coupled to the first port; and
a second set of lenses optically coupled to the second port.

2. The device of claim 1, wherein the first and second ports are on opposing sides of the optical waveguide.

3. The device of claim 1, wherein the first and second ports are on a same side of the optical waveguide.

4. The device of claim 1, wherein the first set of lenses is configured to couple light passing through the first set of lenses into the optical waveguide through the first port.

5. The device of claim 1, further comprising a diffractive structure on the optical waveguide at the first port.

6. The device of claim 1, wherein the second set of lenses is configured to couple light from the second port to form an image between the second set of lenses and a network of mirrors.

7. The device of claim 1, further comprising a diffractive structure on the optical waveguide at the second port.

8. The device of claim 1, wherein each lens in the second set of lenses has a greater diameter than each lens in the first set of lenses.

9. The device of claim 1, wherein the first set of lenses is configured to receive light emitted by a spatial light modulator and provide the light to the optical waveguide through the first port.

10. The device of claim 9, wherein the optical waveguide is configured to receive the light through the first port and to provide the light to the second set of lenses through the second port.

11. The device of claim 10, wherein the second set of lenses is configured to receive the light through the second port and to provide the light to a network of head-up display (HUD) mirrors in an automobile.

12. A device, comprising:
a light source configured to provide light;
a light modulator configured to modulate the light to provide modulated light;
an optical waveguide, a first set of lenses optically coupled between the light modulator and the optical waveguide, and a first port optically coupled between the first set of lenses and the optical waveguide, the first set of lenses configured to provide the modulated light to the optical waveguide through the first port; and
a second set of lenses and a second port optically coupled between the optical waveguide and the second set of lenses, the second set of lenses configured to receive the modulated light from the optical waveguide through the second port and to provide the modulated light,
wherein the second port is larger than the first port.

13. The device of claim 12, further comprising one or more optical elements between the first set of lenses and the light modulator.

14. The device of claim 12, wherein lenses in the second set of lenses are larger than lenses in the first set of lenses.

15. The device of claim 12, further comprising a diffractive structure on the optical waveguide at the first port, at the second port, or a combination thereof.

16. The device of claim 12, wherein the optical waveguide comprises multiple partially reflective mirrors.

17. A vehicle, comprising:
a projector device, comprising:
a waveguide having a first port and a second port, the second port larger than the first port;
a light modulator;
a first set of lenses optically coupled between the first port and the light modulator; and
a second set of lenses optically coupled to the second port;
a glass surface; and
a network of mirrors optically coupled between the second set of lenses and the glass surface.

18. The vehicle of claim 17, further comprising a light source, wherein:
the light source is configured to provide light to the light modulator;
the light modulator is configured to modulate the light and direct the modulated light towards the first set of lenses;
the first set of lenses is configured to provide the light to the waveguide through the first port;
the waveguide is configured to provide the light from the first port to the second port;
the second set of lenses is configured to provide the light from the second port toward the network of mirrors;
the network of mirrors is configured to provide the light toward the glass surface; and
the glass surface is a windshield of the vehicle.

19. The vehicle of claim 17, wherein the first and second sets of lenses are on opposing sides of the waveguide.

20. The vehicle of claim 17, wherein the first and second sets of lenses are on a same side of the waveguide.
